(19) United States
(12) Patent Application Publication
(10) Pub. No.: US 2023/0116149 A1
(43) Pub. Date: Apr. 13, 2023

(54) COPY-PASTE-UPDATE EDIT AUTOMATION

(71) Applicant: Microsoft Technology Licensing, LLC, Redmond, WA (US)

(72) Inventors: Arjun RADHAKRISHNA, Seattle, WA (US); Gustavo ARAUJO SOARES, Seattle, WA (US); Peter GROENEWEGEN, Sammamish, WA (US); Mark Alistair WILSON-THOMAS, Mercer Island, WA (US); Aaron Chak Hei YIM, Seattle, WA (US); Piyush ARORA, Seattle, WA (US); Mohammad RAZA, Redmond, WA (US)

(21) Appl. No.: 17/497,923

(22) Filed: Oct. 9, 2021

(51) Int. Cl. G06F 8/33; G06F 8/36

(52) U.S. Cl. CPC G06F 8/33; G06F 8/36

(57) ABSTRACT

Embodiments automate several aspects of document copy-paste updates. An enhanced editor submits context, such as a copied section, pasted section, nearby text, or parser information, to an automatic suggestion generator. The editor gets back a suggestion for automatically changing the pasted section, thus helping users avoid tedium and errors. For instance, string substitutions begun by the user can be automatically and easily completed within the pasted section. Refactoring between variable declarations and parameter lists is detected and completed on request. Situation-specific transforms based on code synthesis, word associations, temporal edit patterns, anchor target lists, regular expressions, or autocompletion are offered. Suggestions are given inside the user's current workflow to avoid breaks in focus. Suggestions can be refined automatically in response to implicit or explicit user feedback. Users are warned of unedited pasted sections. Code review is aided by highlighting pasted sections.

### BACKGROUND

Programs for creating, modifying, or otherwise editing documents were among the first software tools created, and such editors have undergone many changes over time, including many improvements. Some editing tools accept input not only in the form of characters typed on a keyboard, but also in the form of data sent from a mouse, pen, touch pad, touch screen, microphone, or other device. Some permit a user to define a sequence of keys as a macro, allowing the user to easily repeat a command sequence. Many editors provide a WYSIWYG (what you see is what you get) user experience, so that an appearance of a document onscreen in the editor closely resembles a result of printing the document. Some editing tools support multiple windows, to assist a user who is contemporaneously editing multiple files or editing different parts of a given file, or both. Some editors support integration of graphic images into a document, or provide a user with access to graphics editing tools within a document editing session.

The range of “text” operated upon by an editor was originally limited mostly to alphabet letters, numbers, and punctuation. But over time, the text one can edit with a program has expanded to include at least mathematical symbols, geometric shapes, music and other notational systems, logographic and syllabic scripts, and many other written symbols. As of the present time, the Unicode® technology standard for encoding, representing, and handling text covers over 150 modern and historic scripts, including over 140,000 characters (mark of Unicode, Inc.).

Some editors are specialized for particular knowledge areas or fields of practice, such as video editing, sound editing, or software source code editing. In particular, some source code editors provide integrated functionality for syntax checking, autocompletion, indentation, brace matching, and easy access to a compiler, interpreter, or debugger.

Despite these advancements, improvements are still possible in the field of tools for editing source code or other documents that contain text.

### SUMMARY

Some embodiments described herein automate copy-paste-update editing. Edit automation may suggest an update to a newly pasted section of program source code text based on context such as where the pasted section is located, or an edit to the pasted section by the user, for example. The edit automation may apply the suggestion if the user accepts or modifies the suggestion. Edit automation may warn the user when circumstances indicate that the user forgot to edit part of a pasted section of source code or other text. Document reviewers may be shown where text was copied from, and where text was pasted in, to facilitate source code reviews or other reviews. Automatically generated suggestions may be refined over the course of one or more editing sessions. Other aspects of edit automation are also described herein.

Some embodiments use or provide a hardware and software combination which is configured for edit automation. The combination includes a digital memory, and a processor which is in operable communication with the memory. The processor is configured, e.g., by tailored software, to perform edit automation steps which may include copying a section of a document, pasting the copy into a document, submitting a copy-paste context to an automatic suggestion generator, getting from the automatic suggestion generator a suggestion for a proposed change to the document, and leveraging the suggestion by applying the proposed change to the pasted section or by recommending application of the proposed change to the pasted section, or both. Various tools and techniques for editor copy-paste-update methods are described, along with edit automation methods represented in configured storage devices.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating aspects of a computing system which has one or more of the edit automation enhancements taught herein;

FIG. 3 is a block diagram illustrating an enhanced system configured with copy-paste-update edit automation functionality;

FIG. 4 is a block diagram illustrating some additional aspects of some enhanced systems;

FIG. 5 is a block diagram illustrating some aspects of proposed changes represented in some automatically generated copy-paste-update edit suggestions;

FIG. 6 is a block diagram illustrating some aspects of some editing tool user interfaces;

FIG. 7 is a block diagram illustrating some aspects of some documents that are suitable for copy-paste-update edit automation;

FIG. 8 is a flowchart illustrating steps in some copy-paste-update edit automation methods; and

FIG. 9 is a flowchart further illustrating steps in some methods for edit automation, incorporating FIG. 8.

### DETAILED DESCRIPTION

Overview

Innovations may expand beyond their origins, but understanding an innovation's origins can help one more fully appreciate the innovation. In the present case, some teachings described herein were motivated by Microsoft innovators who recognized and faced technical challenges arising from their efforts to make source code editors more effective and easier to use.

For example, many editors provide users with a command to copy a section of text or other content of a document and then paste the copy into the document at a different location, or into another document. The pasted section can then be edited. In this way, a user can take advantage of existing content by using that content as a starting point to create some other desired content, instead of writing the desired content from scratch.

However, using copy, paste, and manual edits can be tedious and risky. Manual edits may include errors such as character transpositions or other common typing errors. Edits may be accidentally omitted in some situations, such as when some but not all identifiers are updated in pasted source code, or when one of several pasted copies that should have been updated is overlooked. Making complete and correct edits to a source code can be especially difficult when the user is not familiar with the source code and is focused mentally on something other than the edits, e.g., when the user is eager to move to the next set of edits or to start writing some new source code for the program.

For instance, suppose a user has a source code for a function that does an operation, and wants source code for a similar function. With a familiar editor the user could copy the existing source code from a file, paste the copy back into the file, and then edit the copy mostly or entirely in a character-by-character manner. However, an editor enhanced as taught herein could also note the paste, note an initial part of the user's editing effort, and use that as context to get an automated transform which is capable of performing the rest of the desired edit sequence. Instead of typing the rest of the edit sequence by hand, the user could type merely a keystroke or two to accept and apply the suggested transform. This would reduce user typing, and help the user avoid typing errors.

Scenario 1. As a specific example, and with the understanding that the teachings and innovations presented here are not limited to this (or any) specific scenario, suppose the user has the source code shown below that prunes a postiveExamples list, and wants similar source code that will prune a negativeExamples list.

```
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
```

After the user has the editor do a copy and paste, the source looks like the following, with two instances of the code for pruning a postiveExamples list:

```
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
```

Next, the user begins manually editing, by typing that changes an instance of “positive” to “negative” within the if statement condition of the pasted copy:

```
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
// Prune the positiveExamples list
if (negativeExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
```

In response, the enhanced editor sends an automatic suggestion generator the original pasted text (with no “negative”) and the change made in it from “positive” to “negative”, as copy-paste-update context. Based on the context, the automatic suggestion generator generates a suggested transform and returns the suggested transform to the enhanced editor, which presents the suggestion to the user, as shown below.

One or more of the wording, format, and presentation mechanism shown in the example below may be different in other embodiments. In particular, a suggestion may be presented using colored text or background, and may be accompanied by a sound, but colored text and sounds are not permitted within patent documents, so italics and bold are used below. Also, different keystrokes may be used to accept or reject a suggestion than the key combinations shown in the examples herein.

```
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
// Prune the positiveExamples list
if (negativeExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
To change “positive” to “negative” in the pasted area as shown, press
Ctrl+Alt+.
// Prune the negativeExamples list
if (negativeExamples.Count( ) > 10) {
  var unusedNegativeExamples = negativeExamples.Skip(10).ToList( );
  negativeExamples = negativeExamples.Take(10).ToList( );
  Logger.LogInfo($“Ignore { unusedNegativeExamples.Count} negative
examples”);
}
```

Note also that in some embodiments, the gathering of context, the submission of context to the suggestion generator, generation of the context-based suggestion, transmission of the suggestion back to the editor, and visual presentation of the suggestion to the user, all occur quickly enough to seem contemporaneous to the user. For instance, in some embodiments the suggestion is presented after the user finishes replacing the first instance of “positive” by “negative” and before the user has finished replacing a second instance of “positive” by “negative”.

After the suggestion is accepted by the user, the transformed source code looks like this:

```
// Prune the positiveExamples list
if (positiveExamples.Count( ) > 10) {
  var unusedPositiveExamples = positiveExamples.Skip(10).ToList( );
  positiveExamples = positiveExamples.Take(10).ToList( );
  Logger.LogInfo($“Ignore { unusedPositiveExamples.Count} positive
  examples”);
}
// Prune the negativeExamples list
if (negativeExamples.Count( ) > 10) {
  var unusedNegativeExamples = negativeExamples.Skip(10).ToList( );
  negativeExamples = negativeExamples.Take(10).ToList( );
  Logger.LogInfo($“Ignore { unusedNegativeExamples.Count} negative
examples”);
}
```

It may be asserted that a user could instead employ find-replace to find instances of “positive” and replace them by “negative”. However, a conventional find-replace would not be limited to the pasted section, so unwanted changes might be made outside the pasted section. Indeed, a global find-replace would leave the user with two functions to prune the negativeExamples list and no function to prune the positiveExamples list. Avoiding this result would involve repeated find-replace operations with corresponding typing by the user, instead of a single suggestion acceptance keystroke as above. Moreover, transforms generated from cut-paste-update context are not limited to simple string substitution, they may also perform refactoring, reordering, format changes, or other more complex operations.

In short, in many scenarios a precise set of desired changes to source code or other text is not easily made using only manual edits to pasted sections.

Accordingly, a set of technical challenges arise, involving automation of copy-edit-paste editing. One may view these as challenges arising from this technical question: How specifically may an editing tool facilitate appropriate automated editing of pasted sections within a document that is being edited manually by a user?

The present disclosure provides answers to this question, in the form of edit automation functionalities which may be used in various combinations with one another, or alone, in a given embodiment. The identification of suitable context for suggestion generation, the scope of changes to be automatically suggested, the kinds of changes to be suggested and how they may be applied in a document, the circumstances that trigger seeking and getting a suggestion, and other functionalities are described herein.

Operating Environments

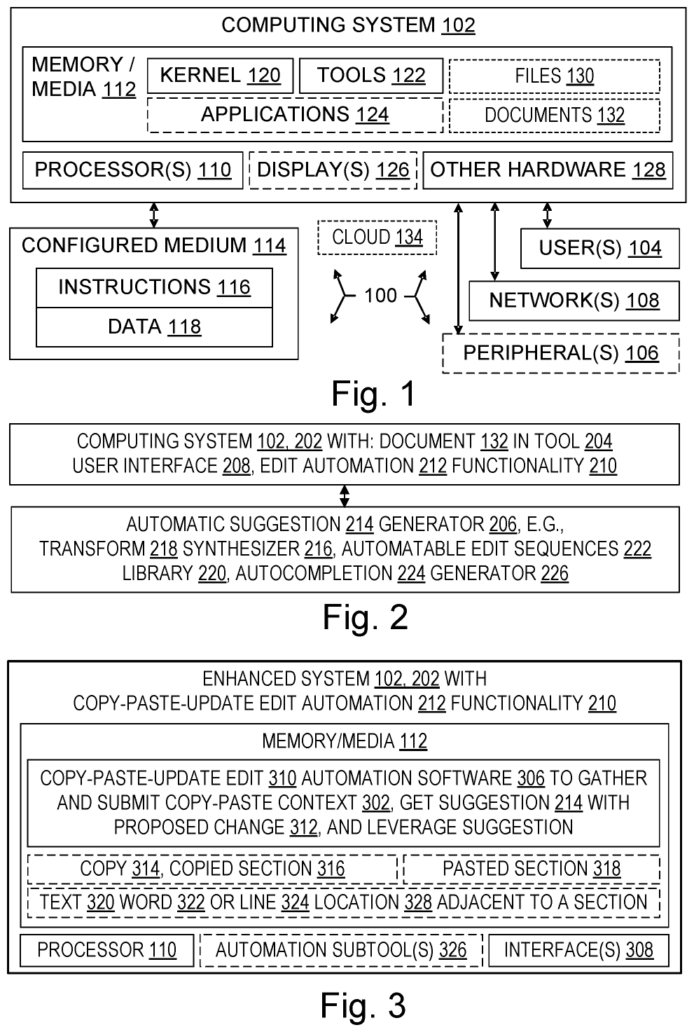

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 134. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112, also referred to as computer-readable storage devices 112. Documents 132 and other files 130 may reside in media 112. Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, edit automation functionality could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience, inclusion of an item in FIG. 1 does not imply that the item, or the described use of the item, was known prior to the current innovations.

More about Systems

FIG. 2 illustrates a computing system 102 configured by one or more of the edit automation enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced.

The illustrated system 202 includes a tool 204, which may be, for example, any tool 122 that also has editing functionality. A document 132 may be brought from a file 130 into the tool 204 for editing in response to input received through a user interface 208. The document 132 may also be displayed on a screen 126 by operation of the user interface 208. Although for simplicity many examples herein refer to a single document, the teachings herein may be applied with multiple documents, e.g., cutting from one document and pasting into another document and then displaying suggestions for changes to that pasted content. The illustrated system 202, and in particular the editing tool 204, is enhanced by the presence and operation of innovative functionality 210 that performs edit automation 212.

Edit automation 212 generally occurs, for example, when a tool 204 makes changes to the document in response to fewer keystrokes or other input gestures than would be required for a user to make the same changes without operation of the edit automation functionality 210. Edit automation 212 may be understood broadly, e.g., to include string find and replace, command macros, and some other familiar editing operations. However, teachings herein go much further, by providing copy-paste-update edit automation functionalities 210 which were not previously available. Innovative edit automation functionality 210 may be used together with the edit automation 212 capabilities of non-enhanced systems, or in some instances as substitutes for such capabilities or enhancements of them.

Some copy-paste-update edit automation functionality 210 taught herein includes or uses an automatic suggestion generator 206 which generates editing suggestions 214. The suggestion generator 206 may include one or more of the following: a transform synthesizer 216 which provides a transform 218, a library 220 of automatable edit sequences 222 with accompanying transforms 218, or an autocompletion 224 generator 226 autocompletion transform 218. Applying a transform 218 changes the document 132, or changes a copy of a portion of the document 132, or does both. A copy of a portion of the document 132 may be transformed to show a user what changes will be made if the transform 218 is applied to the document itself.

Some edit automation functionality 210 taught herein includes or uses a library 220 of automatable edit sequences 222. A given entry in the library 220 includes an edit graph data structure and one or more corresponding temporal edit patterns (TEPs) 402. When the system 202 matches the edit graph to user inputs, the system may recommend that a corresponding TEP be applied to make changes in the document 132. The TEP 402 may thus be viewed as a kind of transform 218, which is associated with an edit graph. Other transforms 218 are not necessarily associated with an edit graph.

A temporal edit pattern 402 is a generalization data structure which represents a group of document edits 310. That is, the TEP 402 may have a coarser granularity than a recording of each edit 310 as it occurred. A TEP 402 may be applied to perform edits at one or more locations, with more flexibility than a simple string find-replace operation.

A TEP 402 may contain one or more edit sequence entry points, representing different edit sequences that ultimately accomplish the same changes. For instance, a TEP 402 for removal of a parameter may have a first entry point which removes the parameter from a method's list of arguments and then removes uses of the parameter within the method's body, and also have a second entry point which removes uses of the parameter within the method's body and then removes the parameter from the method's list of arguments.

Edits 310 may be represented using data structures that track edit operation order and also track edit operation location. Edit operation order is temporal data 408, e.g., timestamps, or sequential numbers, or a list of recent edit operations, or other temporal context. Edit operation location is spatial data 410, e.g., a filename, a line number from the start of the file, a character position or index from the start of the line, or other cursor position data.

Some edit automation functionality 210 taught herein includes or uses an anchor target list (ATL) 404, e.g., a list of identifiers in a pasted section 318. An ATL is a list of document locations, including an anchor location and one or more target locations. After a transform 218 is obtained based on edits at the anchor, the transform may be applied at some or all of the targets. The transform 218 may be more flexible than a simple string find-replace operation. The targets may be identified by a string search, or by any operation that produces a list of document locations. For instance, the list 404 may be (or be extracted from) a list of error locations 418 or warning locations 420 generated by a compiler 416 or another development tool 424, or a list of results from a structural search. A structural search is a search that understands source code tokens such as method calls or source code structures such as loops, as opposed to a string search that treats source code as merely a string of characters.

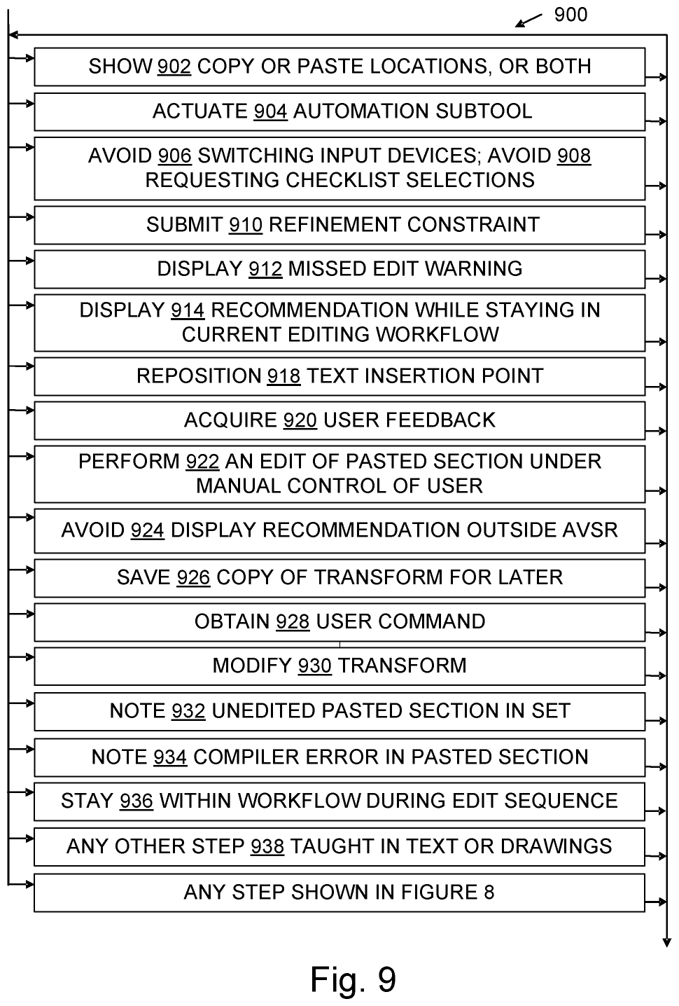

FIG. 3 illustrates an enhanced system 202 which is configured with software 306 to provide edit automation functionality 210. For example, software 306 may perform any one or more of the methods illustrated in FIG. 9 (which incorporates FIG. 8). In particular, software 306 may automate edits 310 by gathering copy-paste context 302, getting a suggestion 214 with a proposed change 312 that was generated from the context 302, and leveraging the suggestion to reduce typing or other input gestures by the user.

The copy-paste context 302 may replicate or otherwise digitally describe one or more of: a copy 314 portion of a copy-paste edit sequence, a copied section 316, a pasted section 318. As understood herein, the text of these items may be identical, but not always, and their respective locations are also not necessarily the same, so they are therefore given respective reference numerals.

As an example, consider a copy-and-paste sequence which edits an initial text “one two three” to produce an edited text “one one two three”. The copied section 316 is the string “one” in the initial text in the document; it would be saved to the file containing the document if the file were closed and saved after the copy. The copy 314 is another string “one” but it resides in a buffer 406, e.g., a clipboard, and it might or might not be preserved after the editor is exited, even if the file is saved. The pasted section 318 is the second string “one” in the edited text in the document; note the editor's automatic addition of a space after “one” in this example. The location of the pasted section 318 in the document is also different than the location of the copied section in this example.

Alternately, one could overwrite the copied section with the pasted section. As another alternative, one could cut-and-paste rather than copy-and-paste. However, one of skill will appreciate that many teachings herein can be readily applied to cut-and-paste situations and to pasting that overwrites the copied section. Helpful suggestions 214 may be presented in either case. Therefore, cut-and-paste situations and pasting that overwrites the copied section are also included within “copy-paste” situations and functionalities discussed herein, except as expressly omitted, or as deemed clearly inapplicable by one of skill in the art.

The copy-paste context 302 may include or otherwise identify part of the text 320 that is adjacent to a copied section 316 or adjacent a pasted section 318, or both. For example, N words 322 or M lines 324 of adjacent text may be part of the context 302, where N and M are non-negative integers defined in the software 306. In some embodiments, M is in the range from ten to one hundred, with a view toward advances in inference based on larger contexts.

Edit automation 212 may include recommending the use of one or more automation subtools 326 to a user who did not expressly look for those subtools (and may not even have known they exist). Edit automation 212 may even apply subtools without expressly identifying them to a user as distinct subtools 326.

The enhanced system 202 may be networked through an interface 308. An interface 308 may include hardware such as network interface cards, software such as network stacks, APIs, or sockets, combination items such as network connections, or a combination thereof.

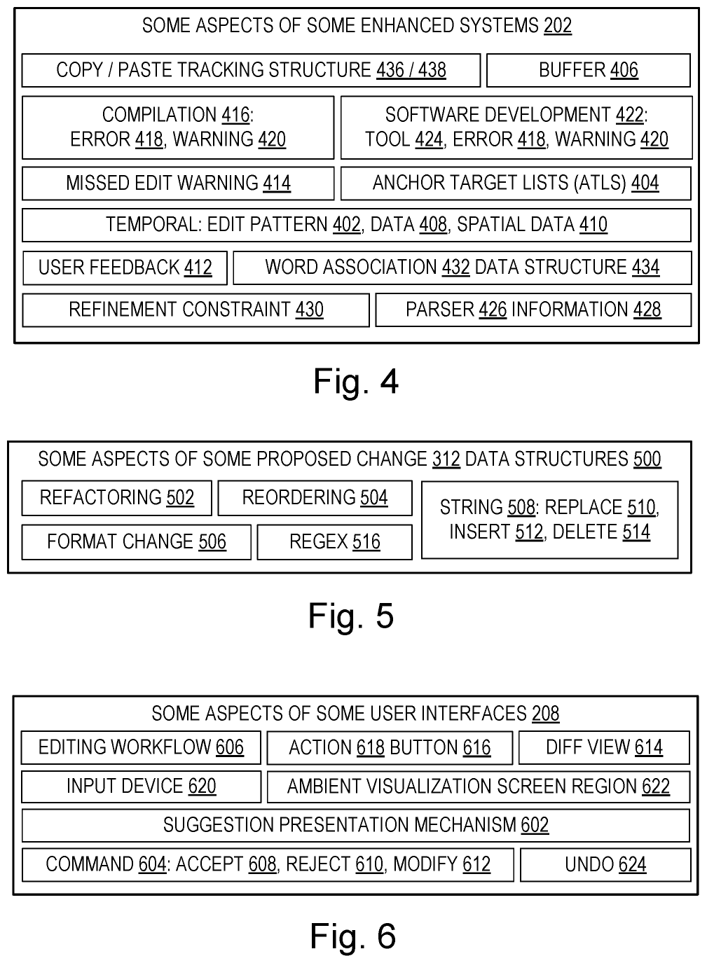

FIG. 4 shows some aspects of some enhanced systems 202. This is not a comprehensive summary of all enhanced system aspects or of every enhanced system 202. These items are discussed at various points herein, and additional details regarding them are provided in the discussion of a List of Reference Numerals later in this disclosure document.

FIG. 5 shows some aspects of some proposed change data structures 500, and hence of proposed changes 312 themselves. This is not a comprehensive summary of all aspects of proposed changes to documents 132 in a given embodiment, or in every embodiment. These items are discussed at various points herein, and additional details regarding them are provided in the discussion of a List of Reference Numerals later in this disclosure document.

FIG. 6 shows some aspects of some user interfaces 208. This is not a comprehensive summary of all user interface aspects, or of every user interface 208. These items are discussed at various points herein, and additional details regarding them are provided in the discussion of a List of Reference Numerals later in this disclosure document.

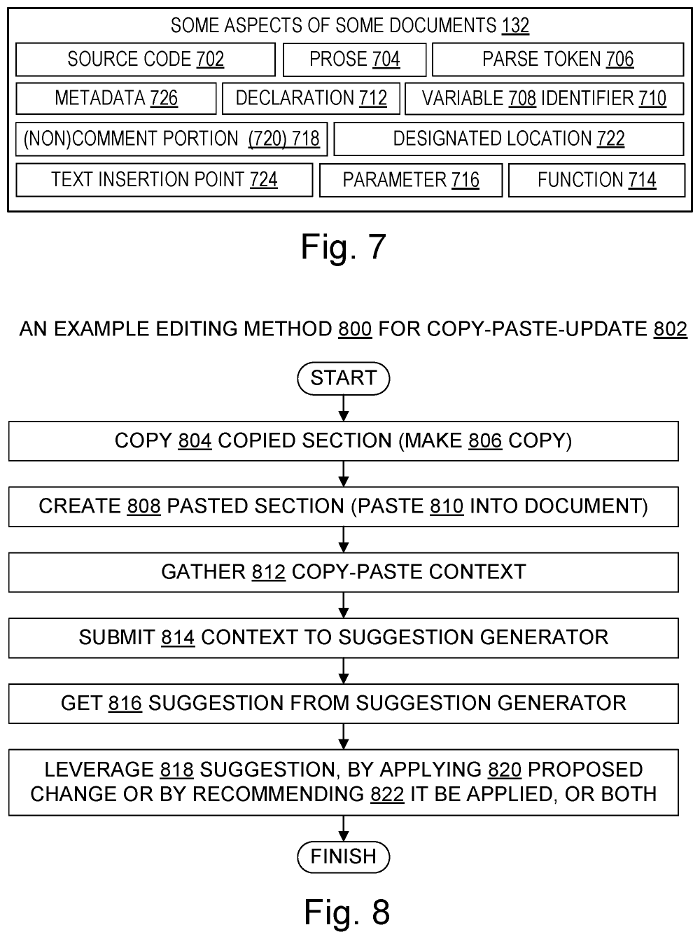

FIG. 7 shows some aspects of some documents 132. This is not a comprehensive summary of all document aspects, or of every document 132. These items are discussed at various points herein, and additional details regarding them are provided in the discussion of a List of Reference Numerals later in this disclosure document.

Some embodiments use or provide functionality 210 which gets an automatically generated suggestion 214 for an update to a pasted section 318 after the user does at least a copy and a paste, and then either displays the suggestion or applies it, or both. Depending on the embodiment, this functionality 210 operates in situations where a suggestion is made right after the paste before further user action, or in situations where a suggestion is not made until the user has done some editing to the pasted section, or in both kinds of situation.

In some embodiments, an enhanced system 202 which is configured to receive a copy-paste editing operation sequence and then automatically recommend or apply an additional editing operation includes a digital memory 112, and a processor 110 in operable communication with the memory. The processor 110 is configured to perform editing automation steps. As noted elsewhere herein, digital memory 112 may be volatile or nonvolatile or a mix. The steps include (a) making a copy 314 at least in part by copying a copied section 316 of a first document 132, (b) creating a pasted section 318 at least in part by pasting the copy into the first document or into a second document, (c) automatically and proactively submitting a copy-paste context 302 to an automatic suggestion generator 206, (d) getting a suggestion 214 from the automatic suggestion generator in response to the submitting, the suggestion including a proposed change 312 to the pasted section, and (e) leveraging the suggestion by applying the proposed change to the pasted section or by recommending application of the proposed change to the pasted section, or both. In this example, the copy-paste context 302 includes at least one of the following: at least a portion of the copied section, at least one word 322 of text 320 adjacent to the copied section, or at least one word 322 of text adjacent to the pasted section. An adjacent word may be visible, or it may be an internal location marker or parser information that is not necessarily displayed to users.

Some embodiments keep track of copies and pastes, by using a data structure inside one or more documents 132. A given document 132 may thus be viewed broadly as including both displayed text and a markup or other internal data that is not normally displayed to users. With copy-paste tracking, a reviewer 104 of the document can say, e.g., “show me where source code was pasted into this file” or “show me locations from which source code was copied to the clipboard”.

In particular, some embodiments include a document 132, which resides in the digital memory 112, and the document includes at least one of the following: a paste tracking data structure 438 which identifies at least a location 722 of the pasted section 318 and indicates that the pasted section was pasted into the document; or a copy tracking data structure 436 which identifies at least a location 722 of the copied section 316 and indicates that the copied section was copied into a memory buffer 406 from which content 118 can be pasted into the document. Use of the present tense corresponds to the understanding that the content cannot be pasted after contrary action is taken, e.g., overwriting the buffer with different content.

Although many of the examples herein involve source code 702, one of skill will acknowledge that many of the teachings provided herein can be applied as well to text 320 which is not source code. A variety of documents 132 are relevant, in that copy-paste-update is not limited to use in editing source code.

In particular, some embodiments include a document 132, which resides in the digital memory 112, and the document includes at least one of the following: text 320 which includes computer program source code 702; text which adheres to a syntax that is automatically parseable into tokens 706; or text which includes natural language prose 704.

Source code is automatically parseable into tokens 706, but so also is some text that is not source code, e.g., spreadsheet content. Spreadsheets, configuration files, data packets, log files, and many other kinds of documents are not source code but nonetheless have some structure that is usable for finding related text by more than mere string matching. By contrast, much prose 704 is too unstructured to permit parsing. However, copy-paste-update edit automation functionality 210 may be advantageously applied with each kind of text.

Moreover, copy-paste-update edit automation functionality 210 may be advantageously applied with a wide variety of changes 312 to a document 132. Some embodiments include a proposed change data structure 500 in the digital memory 112. The proposed change data structure represents the proposed change 312, and the proposed change includes at least one of the following: a string replacement 510; a string insertion 512; a string deletion 514; a source code refactoring 502; a reordering 504 of source code tokens; a reordering 504 of characters; a reordering 504 of words; a reordering 504 of lines of text; a format change 506; or an autocompletion 224.

Some embodiments offer suggestions 214 that are based at least in part on a word association 432. Some words are often used together, e.g., positive-negative, begin-end, include-exclude, from-to, and words representing operators such as “<” and “>” (words are not limited to natural language dictionary entries). Such associations 432 can guide an embodiment's activity. In a variation of the Scenario 1 example provided herein, an enhanced system could suggest changing “positive” to “negative” even before the user finishes the first edit to make that change, by noting that the user is editing a string that includes “positive” and based on the association of “negative” with “positive”.

In particular, some embodiments include a word associations data structure 434 in the digital memory, the word associations data structure representing word associations 432. The proposed change 312 includes a change from a first word to a second word, and the word associations data structure represents an association between the first word and the second word.

One of skill will acknowledge that the user edits 310 which are given to the suggestion generator 206 could match a known pattern 402, such as a known refactoring pattern, or they might not match any available pattern. If they don't match any known pattern then the edits can still be fed to a PROSE synthesizer or a CODEX code synthesis engine or a similar transform synthesizer 216 serving as a suggestion generator 206.

In view of teachings herein, one of skill will acknowledge that some UI mechanisms 602 are more intrusive upon a developer's current workflow 606 than other UI mechanisms. For example, requiring that a developer open another window and do a keyword search to locate potentially useful subtools 326 is much more intrusive than recommending 822 a particular refactoring subtool 326 from a library 220 be applied.

Some embodiments use or provide a diff view 614 in the user interface for presentation of recommendations 214. The diff view may be with or without buttons 616 for performing actions 618 to accept, reject, or otherwise perform a user's indicated response to a recommendation. In a diff view, a result of accepting the recommendation is shown inline or in an adjacent line, and is visually distinguished by color, font, bold, italic, or otherwise. In the following example, the source code that will be replaced is shown in strike-through format, and is followed on the line by the code that will replace it:
{Node (str id) {

A diff view may omit buttons 616, e.g., when keys are designated to indicate accept or reject actions, e.g., tab means accept the recommendation and space means reject the recommendation. After acceptance, the code would look like this:
Node (str id) {

After rejection, the code would look like this:
Node ( ) {

The same recommendation is shown in the following variant diff view, which does display buttons, to be actuated by the indicated bold capital letters: accept all in File|Reject all|accept all in Project
{Node (str id) {

Other system embodiments are also described herein, either directly or derivable as system versions of described processes or configured media, duly informed by the extensive discussion herein of computing hardware.

Although specific edit automation architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different technical features, aspects, mechanisms, operational sequences, data structures, or other functionalities for instance, and may otherwise depart from the examples provided herein.

Processes (a.k.a. Methods)

FIGS. 8 and 9 illustrate families of methods 800, 900 (which may also be referred to as “processes” in the legal sense of that word) that may be performed or assisted by an enhanced system, such as system 202 or another edit automation functionality enhanced system as taught herein. FIG. 9 includes some refinements, supplements, or contextual actions for steps shown in FIG. 8, and incorporates the steps of FIG. 8 as options.

Technical processes shown in the Figures or otherwise disclosed will be performed automatically, e.g., by an enhanced editor 204, a subtool 326, or a transform provider 206, unless otherwise indicated. Processes may also be performed in part automatically and in part manually to the extent action by a human person is implicated, e.g., in some embodiments a human may manually indicate acceptance of a recommendation and thereby trigger application 820 of the recommendation 214, but no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 8 and 9. Steps may be performed serially, in a partially overlapping manner, or fully in parallel. In particular, the order in which flowchart 800 or 900 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method 900 for edit automation in a first document 132, the method performed by an editor program 204, the method including: making 806 a copy 314 at least in part by copying 804 a copied section 316 of the first document; creating 808 a pasted section 318 at least in part by pasting 810 the copy into the first document or into a second document; automatically and proactively submitting 814 a copy-paste context 302 to an automatic suggestion generator 206; getting 816 a suggestion 214 from the automatic suggestion generator in response to the submitting, the suggestion including a proposed change 312 to be made only in the pasted section in the absence of user instructions to the contrary; and leveraging 818 the suggestion, by applying 820 the proposed change to the pasted section only, or by recommending 822 application of the proposed change to the pasted section only, or both. In this method example, the copy-paste context 302 includes at least the copied section or the pasted section. Also, the proposed change 312 may be included in the form of a data structure 500 which is contained in or identified by the suggestion 214.

In some embodiments and some situations, a suggestion is not made until the user has done some editing to the pasted section. The user's editing is part of the context submitted to the suggestion generator. In some, the method includes performing 922 an edit 310 of the pasted section before submitting 814 the copy-paste context, and the copy-paste context 302 includes a digital representation of the edit.

Some embodiments use source code around the copied section, or source code around the pasted section, or both, as context 302 for the suggestion generator. An example is provided in Scenario 3. Some embodiments use parser information 428 as context 302, e.g., to represent copying from a class declaration, pasting into a class declaration, copying from or pasting into a list of routine parameters, and so on.

In particular, in some embodiments the copy-paste context 302 includes at least one of the following: source code 702 which is outside the copied section and which is separated from the copied section by at most one hundred lines 324; parser information 428 which represents the copied section 316; source code which is outside the pasted section and which is separated from the pasted section by at most one hundred lines 324; or parser information 428 which represents the pasted section 318.

Some embodiments warn a user that an edit to a pasted section may have been overlooked. This could be an additional edit within a given pasted section, or an unedited pasted section among several pasted sections, for example, as in Scenario 5. In the latter case, a trigger for warning the user that they might have missed doing an edit could be the user moving the cursor outside the pasted sections, for example.

In particular, in some embodiments the method creates 808 multiple pasted sections by pasting 810 the copy 314 into the document multiple times; at least one of the multiple pasted sections 318 is edited in response to one or more commands 604 from a user; and then the method automatically and proactively displays 912 a warning 414 to the user that a pasted section has not been edited.

Some embodiments recognize refactoring 502 situations that involve two or more different identifiers 710, such as refactoring variable declarations 712 into method 714 arguments 716, refactoring method arguments into variable declarations, or refactoring to or from a list of identifiers in a switch statement, for example. Scenario 2 includes an example.

In particular, in some embodiments of the method, the pasted section 318 includes multiple variable 708 identifiers 710, and the proposed change 312 includes a refactoring 502 of a source code 702 which recites at least two of the variable identifiers.

Some embodiments provide suggestions 214 for performing string 508 substitutions, e.g., as in the Scenario 1 example changing “positive” to “negative”.

In particular, in some embodiments at least one of the following conditions is satisfied: the proposed change 312 includes a first proposed change to a first identifier 710 in a source code non-comment portion 720 of the pasted section and also includes a second proposed change to a second identifier in the source code non-comment portion (e.g., unusedNegativeExamples and negativeExamples variables in an example above); or the proposed change 312 includes a first proposed change to an identifier 710 in a source code non-comment portion 720 of the pasted section and also includes a second proposed change to a string in a source code comment portion 718 of the pasted section (e.g., change positiveExamples to negativeExamples, change currentPositiveEx to currentNegativeEx, and change the string “Handled n positive examples” to “Handled n negative examples” in the comment).

Some embodiments skip over reserved words to reach the first point in the pasted section where a change would be made if the suggestion is accepted by the user. Examples of setting a text insertion point 724 are given in Scenario 3 and Scenario 4 herein.

In particular, some embodiments automatically and proactively reposition 918 a text insertion point 724 within the pasted section 318 to match a location 722 of the proposed change 312.

In some embodiments, the pasted section 318 includes a variable 708, and the proposed change 312 includes a function 714 which can receive the variable as a parameter 716. In some, the function abstracts an intent of the copied section into a routine 714 to facilitate reuse of a functionality that is implemented more particularly by the copied section.

For example, as a variation of Scenario 1, an embodiment may detect copy-paste-modify and offer 822 to write a parameterized version of the pasted code 318 in the form of a function, which the user can utilize instead of generating similar boilerplate. In the case of list pruning per Scenario 1, a suggested function pruneList(listToPrune, directionOfPrune) would be defined to receive positiveExamples via the parameter listToPrune, along the lines of the following code:

```
function pruneList( listToPrune, directionOfPrune )
{
if (listToPrune.Count( ) > 10) {
  var unusedListToPrune = listToPrune.Skip(10).ToList( );
  listToPrune = listToPrune.Take(10).ToList( );
  Logger.LogInfo($“Ignore { unusedListToPrune.Count} {
directionOfPrune } examples”);
}
```

Some embodiments use compiler or tool warnings 420 or other diagnostic info 418 as context 302 for the suggestion generator. An example is provided in Scenario 5. More generally, some embodiments use parser information 428 as context 302. That is, the copy-paste context 302 includes parser information 428.

A variety of suggestion generator technologies can be used. In some embodiments, the submitting 814 submits the copy-paste context 302 to at least one of the following automatic suggestion generators 206: a transform synthesizer 216, an automatable edit sequences library 220 containing temporal edit patterns 402, or an autocompletion code generator 226. These generators 206 are available to one of skill in the art, and an embodiment may also or instead take advantage of future generator improvements by submitting 814 context 302 and getting 816 suggestions 214.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as anchor target lists 404, temporal edit patterns 402, transforms 218, libraries 220, temporal data 408, spatial data 410, copy-paste context 302, suggestions 214, or edit automation software 306, in the form of data 118 and instructions 116, read from a removable storage medium 114 and/or another source such as a network connection, to form a configured storage medium. The configured storage medium 112 is capable of causing a computer system 102 to perform technical process steps for edit automation, as disclosed herein. The Figures thus help illustrate configured storage media embodiments and process (a.k.a. method) embodiments, as well as system and process embodiments. In particular, any of the process steps illustrated in FIG. 8 or 9, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform a method for edit automation. This method includes: making 806 a copy at least in part by copying a copied section of a first document; creating 808 a pasted section at least in part by pasting the copy into the first document or into a second document; automatically and proactively submitting 814 a copy-paste context 302 to an automatic suggestion generator; getting 816 a suggestion from the automatic suggestion generator in response to the submitting, the suggestion including a proposed change; and recommending 822 application of the proposed change to the pasted section only; wherein the copy-paste context includes at least the copied section or the pasted section.

In some embodiments, the method further includes at least one of the following: obtaining 928 via a user interface an accept command 608, and in response applying 820 the proposed change to the pasted section; obtaining 928 via the user interface a reject command 610, and in response avoiding applying the proposed change to the pasted section; or obtaining 928 via the user interface a modify command 612, modifying 930 the proposed change into a modified proposed change, and applying the modified proposed change to the pasted section.

In some embodiments, the method further includes: acquiring 920 a user feedback 412 about the proposed change; submitting 910 a refinement constraint 430 to the automatic suggestion generator, the refinement constraint being based on the user feedback; getting 816 a refined proposed change from the automatic suggestion generator; and leveraging 818 the refined proposed change by applying the refined proposed change or by recommending application of the refined proposed change, or both. The refinement constraint may include, e.g., user edits to a transform, or user acceptance or rejection of a transform, and the feedback 412 may be positive or negative or a mix of both. In some embodiments, the user feedback 412 includes at least one of the following: an undo request 624 to undo at least part of an application 820 of a suggestion; an edit to a transformed pasted section; at least two rejections of recommended applications of the transform (not necessarily in a row); or a cancelation or dismissal of the transform (e.g., reject all, or reject the rest of the suggested locations from here on). An edit to a transformed pasted section may occur when the user accepted a suggestion but then revised the result of applying the suggestion.

In some embodiments, leveraging the transform stays 936 within a current editing workflow 606 in at least one of the following ways: by avoiding 906 switching between input devices 620 while receiving a user input which accepts, rejects, or modifies a displayed recommendation (e.g., no switching between mouse and keyboard); avoiding 908 requesting checklist constraints from the user (e.g., no need to fill in a checklist or select multiple criteria); or avoiding 924 displaying, outside of an ambient visualization screen region 622 of the user interface, the recommendation 214 (e.g., avoid recommendations in popups or separate windows but allow them in completion lists and diff views).

Some embodiments facilitate, allow, or favor staying within a current editing workflow 606. This may be accomplished, e.g., by not switching input devices (mouse v. keyboard), staying within an ambient visualization area 622, and using acceptable in-flow adornments such as diff view or autocompletion list or refactoring annotation or pop-up instead of flow-breaking adornments such as a light bulb or a separate window or file or a dialog box. Accordingly, in some embodiments include recommending 822 application of the proposed change 312 stays 936 within a current editing workflow 606. One advantage of staying in a workflow is that the traditional functionalities within the flow remain available, e.g., source code formatting and autocompletion are available in-flow in some IDEs but not available in a separate window or other out-of-flow context.

In some embodiments, applying 820 a proposed change “only” within a pasted section does not prevent applying the same proposed change later within another pasted section. Rather, it respects the scope of the pasted section in a way that a global find-replace or global reformatting does not. Thus, some embodiments include creating 808 a second pasted section, and recommending 822 application of the proposed change to the second pasted section only. For instance, suppose a copied section includes several instances of a string “testlib” and several instances of a string “sales”, and suppose that two pasted sections are created from that copy. Then a pair of suggestions (or a combined single suggestion) could recommend changing “testlib” to “prodlib” and “sales” to “md” in only the first pasted section as opposed to in the entire file, and recommend changing “testlib” to “prodlib” and “sales” to “legal” in only the second pasted section as opposed to changing the entire file.

Some embodiments include saving 926 a copy of the transform 218 or the entire suggestion in a digital format which allows subsequent use or reuse. Additionally, since the generator 206 may keep a formal representation that encodes the user intent, some embodiments provide is an opportunity to reuse and share past edits. For instance, a user may encounter a similar change in the near future and they can use the embodiment to keep the old edits around. Beyond personal reuse, since multiple developers tend to work on the same codebase in realistic settings, it is also possible to share saved edits with peers. This may be done in a manner that allows lighter-weight creation and maintenance of code transforms shared across individual developers than other approaches. When transforms are reused, the interactive experience of an embodiment also allows for refinement of existing transforms. As a result, users can incrementally build up understanding of and confidence in existing transformations as they interact with them through an embodiment.

### Additional Examples and Observations, Generally

Additional support for the discussion of edit automation herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, additional examples and observations are offered.

Scenario 1 provided above illustrates various aspects of some edit automation functionality 210 using specific source code text. In this scenario, an enhanced system 202 offers to do additional string substitutions in identifiers and in comments within a pasted area after the user does the first string substitution edit. After a suggestion changing instances of “positive” to “negative” is accepted, the same user or another user could bring the document into a tool 204 (not necessarily with edit capabilities, or as read-only) and enter a command 604 to show pasted areas. This would assist code review, for example.

Scenario 2. In this scenario, an enhanced system 202 recognizes that variable declarations 712 have been pasted 810 into a body of a method 714 that is under construction by the user, and the enhanced system 202 offers to refactor the variable declarations into arguments 716 of the method. This offer may be made before the user starts manually editing the pasted section (a copy-paste-suggest operational sequence), based on the parser information in the context 302. Or the suggestion may be offered after some manual editing of the pasted section (a copy-paste-edit-suggest operational sequence).

As an illustrative example with specific source code, before the paste 810 and before context would indicate a method 714 is desired, the following source code 702 is present in the document being edited:

```
class Connection {
  private string uri;
  private string protocol;
  private int port;
}
```

Next, the user does manual editing that indicates a method 714 is desired, by declaring the method Initiate( ):

```
class Connection {
  private string uri;
  private string protocol;
  private int port;
  public void Initiate(
  ) {
  }
}
```

Then the user commands a copy and paste which creates 808 a pasted section of copied variable declarations within the scope of a parameter list of the method Initiate( ):

```
class Connection {
  private string uri;
  private string protocol;
  private int port;
  public void Initiate(
  private string uri;
  private string protocol;
  private int port;
  ) {
  }
}
```

The enhanced system 202 gathers 812 context 302 that includes parser information representing the variable declarations in the scope of the method's parameter list, submits 814 the context 302, and gets 816 a suggestion that includes changing 312 the pasted declarations into a correct syntax for a parameter list. After the user accepts 608 the suggestion, the source code looks like this:

```
class Connection {
  private string uri;
  private string protocol;
  private int port;
  public void Initiate(
    string uri,
    string protocol,
    int port
  ) {
  }
}
```

Scenario 3. In this scenario, an enhanced system 202 recognizes that a variable declaration is pasted into a class declaration, skips 918 over reserved words to the variable's name, and suggests a replacement based on past edits as represented in an association 432 of identifier names “from” and “to”. Before the pasting, the particular source code used in this example includes the following:

class RangeCharSet {
public char from { get; private set; }

After the pasting, the source code looks like this:

```
class RangeCharSet {
  public char from { get; private set; }
  public char from { get; private set; }
```

Based on context 302 that includes pasted text, a suggestion is offered to change “from” into “to”:

```
class RangeCharSet {
  public char from { get; private set; }
  public char from { get; private set; }
```

To change “from” to “to” in the pasted area as shown, press Ctrl+Alt+.

public char to { get; private set; }

After the suggestion is accepted:

```
class RangeCharSet {
  public char from { get; private set; }
  public char to { get; private set; }
```

Scenario 4. In this scenario, an enhanced system 202 recognizes that a sequence of pastes has been performed, and jumps 918 to a likely edit point. This scenario also illustrates that changes may be made 820 stepwise within a pasted area. Before the pasting, the particular source code in this example look like the following, in which a cursor at the text insertion point text is shown as a vertical bar |:

|SetSecurityAndNotify(cond); // Set security level, display status

After a copy is made and pasted several times, the display includes the following; note the insertion point at the end of the last pasted section:

SetSecurityAndNotify(cond); // Set security level, display status
SetSecurityAndNotify(cond); // Set security level, display status
SetSecurityAndNotify(cond); // Set security level, display status
SetSecurityAndNotify(cond); // Set security level, display status|

After a manual edit changed “Security” to “Cost”, the display shows:

SetSecurityAndNotify(cond); // Set security level, display status
SetCost|AndNotify(cond); // Set security level, display status
SetSecurityAndNotify(cond); // Set security level, display status
SetSecurityAndNotify(cond); // Set security level, display status

After a suggestion 214 is offered to propagate the change from “Security” to “Cost”, the display shows:

SetSecurityAndNotify(cond); // Set security level, display status
SetCostAndNotify(cond); // Set |security level, display status
SetSecurityAndNotify(cond); // Set security level, display status
SetSecurityAndNotify(cond); // Set security level, display status
To change next instance of “security” to “cost” in the pasted area as shown, press Ctrl+Alt+,
SetCostAndNotify(cond); // Set cost level, display status

After the suggestion is accepted, the text insertion point is moved 918 to a next likely edit location, at the start of the next instance of “Security”:

SetSecurityAndNotify(cond); // Set security level, display status
SetCostAndNotify(cond); // Set cost level, display status
Set|SecurityAndNotify(cond); // Set security level, display status
SetSecurityAndNotify(cond); // Set security level, display status

Scenario 5. In this scenario, an enhanced system 202 recognizes that an edit was apparently missed in a sequence of edits that were made to pasted sections. This may be viewed as a copy-paste-paste-paste-edit-edit-suggest operational sequence. Before copying 804, the particular source code text used in this example looks like this:

int level0;

After the copy and several pastes 810, the source code looks like this:

int level0;
int level0;
int level0;
int level0;
int level0;
int level0;
int level0;
int level0;
int level0;
int level0;
int level0;

After several manual edits 310 to respective pasted areas, the source code looks like this:

int level0;
int level1;
int level2;
int level3;
int level4;
int level5;
int level6;
int level7;
int level8;
int level9;
int level0;

Next, the user tries to move the cursor to leave the pasted areas. But a suggestion 214 points out that another edit might have been overlooked, based on noting 932 that some but not all of the pasted texts were edited:

int level0;
int level1;
int level2;
int level3;
int level4;
int level5;
int level6;
int level7;
int level8;
int level9;
int level0; <-Do you want to also edit this pasted text?

As an alternative to triggering the warning 912 on the basis that some but not all of the pasted texts were edited, or in addition to doing so, in some enhanced systems 202 a background compilation indicates a compilation error (level0 is declared twice) noted 934 by the enhanced tool 204, and accordingly a suggestion points out 912 that another edit might have been overlooked, based on the compilation error:

int level0;
int level1;
int level2;
int level3;
int level4;
int level5;
int level6;
int level7;
int level8;
int level9;
int level0; <-This recently pasted text does not compile; press Ctrl-Alt+. to edit it to match the other recent pastes by changing “level0” to “level10”

Technical Character

The technical character of embodiments described herein will be apparent to one of ordinary skill in the art, and will also be apparent in several ways to a wide range of attentive readers. Some embodiments address technical activities such as executing edit automation software 306, communicating 814, 816 with a suggestion generator 206, applying 820 transforms to edit a document in a software tool 204, actuating 904 automation subtools 326, and repositioning 918 a text insertion point, which are each an activity deeply rooted in computing technology. Some of the technical mechanisms discussed include, e.g., copy tracking data structures 436, paste tracking data structures 438, word association data structures 434, temporal edit patterns 402, anchor target lists 404, edit automation subtools 326, automatable edit sequence libraries 220, transforms 218, and suggestion generators 206. Some of the technical effects discussed include, e.g., enhanced discoverability of available subtools 326 generally and in mitigation of late awareness in particular, enhanced discovery of similar locations to which a transform may apply (even to the extent of sharing locations or a location-identifying pattern across a team or across a project or codebase), improved user satisfaction and productivity from staying 936 within a workflow during edit automation, review with tighter scrutiny of pasted source code, detection of pasted sections whose editing may have been accidentally overlooked, and faster and more accurate editing. Thus, purely mental processes and activities limited to pen-and-paper are clearly excluded. Other advantages based on the technical characteristics of the teachings will also be apparent to one of skill from the description provided.

Some embodiments described herein may be viewed by some people in a broader context. For instance, concepts such as availability, awareness, ease, efficiency, or user satisfaction, may be deemed relevant to a particular embodiment. However, it does not follow from the availability of a broad context that exclusive rights are being sought herein for abstract ideas, they are not. Rather, the present disclosure is focused on providing appropriately specific embodiments whose technical effects fully or partially solve particular technical problems, such as how to automatically and effectively utilize edit automation subtools 326 that are difficult for users to discover manually. Other configured storage media, systems, and processes involving availability, awareness, ease, efficiency, or user satisfaction are outside the present scope. Accordingly, vagueness, mere abstractness, lack of technical character, and accompanying proof problems are also avoided under a proper understanding of the present disclosure.

Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples, operating environments, time period examples, software processes, security tools, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GPU: graphical processing unit

GUI: graphical user interface

GUID: globally unique identifier

IaaS or IAAS: infrastructure-as-a-service

ID: identification or identity

LAN: local area network

OS: operating system

PaaS or PAAS: platform-as-a-service

RAM: random access memory

ROM: read only memory

SIEM: security information and event management; also refers to tools which provide security information and event management

TPU: tensor processing unit

UEFI: Unified Extensible Firmware Interface

WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

With regard to editor user interfaces, “find” and “search” mean the same thing as each other herein.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Edit automation operations such as applying 820 transforms, communicating 814, 816 with a suggestion generator 206, repositioning 918 a text insertion point, copying 804 text, pasting 810 text, and many other operations discussed herein, are understood to be inherently digital. A human mind cannot interface directly with a CPU or other processor, or with RAM or other digital storage, to read and write the necessary data to perform the edit automation steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as actuating, applying, copying, displaying, editing, getting, leveraging, modifying, noting, obtaining, offering, pasting, placing, providing, receiving, recommending, saving, submitting, utilizing (and actuates, actuated, applies, applied, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment
102 computer system, also referred to as a “computational system” or “computing system”, and when in a network may be referred to as a “node”
104 users, e.g., user of an enhanced system 202
106 peripherals
108 network generally, including, e.g., LANs, WANs, software-defined networks, clouds, and other wired or wireless networks
110 processor
112 computer-readable storage medium, e.g., RAM, hard disks
114 removable configured computer-readable storage medium
116 instructions executable with processor; may be on removable storage media or in other memory (volatile or nonvolatile or both)
118 data
120 kernel(s), e.g., operating system(s), BIOS, UEFI, device drivers
122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, and so on
124 applications, e.g., word processors, web browsers, spreadsheets, games, email tools, commands
126 display screens, also referred to as “displays”
128 computing hardware not otherwise associated with a reference number 106, 108, 110, 112, 114
130 file, blob, table, container, or other digital storage unit(s)
132 digital document, e.g., word processor document, spreadsheet document, source code document, or other document in digital (computer-readable and software-editable) format; may include text, graphics, sound, etc.; may be stored in one or more files 130
134 cloud
202 system 102 enhanced with edit automation functionality 210
204 tool 122 or application 124 enhanced with edit automation functionality 210
206 transform provider, e.g., example-driven synthesizer of pattern match codes or of both pattern match codes and transforms 218; such a synthesizer may use Microsoft PROSE™ technology or another program synthesis technology to synthesize pattern match code, or text transforms, or both, that implement computational operations that produce the desired results (mark of Microsoft Corporation); transform provider may also or instead include a library 220; also referred to as “suggestion generator”
208 user interface generally; part of a tool 204
210 copy-paste-update edit automation functionality, e.g., functionality which performs steps 812, 814, 816, and 818, or an implementation providing functionality for any previously unknown method or previously unknown data structure shown in any Figure of the present disclosure
212 edit automation generally
214 recommendation from system to user for an editing operation; also referred to as “suggestion” or “offering”; may refer to the content describing the recommendation or to a result described in that content; refers to a data structure
216 transform synthesizer
218 transform, e.g., a script, regex, subtool, or other computational mechanism which upon execution (also referred to as “actuation” or “application”) automatically edits text
220 library of automatable edit sequences; each library entry has a pattern matching portion (e.g., edit graph) and a transform portion (e.g., TEP 402)
222 automatable edit sequence, e.g., an entry in a library 220; depending on context, the pattern matching portion of an entry may also be referred to on its own as an automatable edit sequence, as may a sequence of edits 310 that match the pattern matching portion; also refers to edit sequence data structure
224 completion edit automation; also called “autocompletion”
226 autocompletion generator, e.g., code which upon execution performs autocompletion during source code editing, such as Visual Studio® IntelliCode™ or IntelliSense™ autocompletion code (marks of Microsoft Corporation)
302 copy-paste context; digital data structure
306 edit automation software, e.g., software which performs any method according to any of the Figures herein or utilizes any data structure according to any of the Figures herein
308 interface generally to a system 102 or portion thereof; may include, e.g., shells, graphical or other user interfaces, network addresses, APIs, network interface cards, ports
310 edit, e.g., version change in a document
312 proposed change; generated by a suggestion generator based at least in part on copy-paste context; may also refer to a proposed change that has been applied
314 copy of text or other document content; digital
316 copied section of document; digital
318 pasted section of document; digital
320 text; digital
322 word of text; “word” is meant broadly to include not merely dictionary words and source code identifiers but also operators such as < and > and numbers
324 line in a source code or other text document; terminated by newline or wraparound, for example
326 edit automation subtool, whether pre-existing or created hereafter
328 location generally; refers to any location in a document 132
402 temporal edit pattern data structure
404 anchor target list data structure or any list of one or more designated locations; data structure; e.g., a list of highlighted locations, or bookmarked locations, or user-generated locations, or any other list of locations
406 memory buffer, e.g., cut-and-paste buffer or clipboard
408 temporal data; an example of data 118 representing a point in time or events, involving one or more documents
410 spatial data; an example of data 118 representing location in one or more documents
412 data structure representing user feedback regarding a transform, anchor target list, or other computational product
414 missed edit warning, e.g., alert, dialog box, audible warning, pop-up, highlighting, or other presentation to a user indicating that an edit to a pasted section may have been inadvertently omitted by the user
416 compilation; may refer to a compiling process, compiler, or a result of compiling
418 error generally, e.g., message for corresponding location at which an apparent error has been found by a tool 122, or the corresponding location itself, or any data structure representing either; reference numeral 418 may also refer to the location of the error
420 warning generally, e.g., message for corresponding location at which a notable circumstance has been found by a tool 122, or the corresponding location itself, or any data structure representing either; reference numeral 420 may also refer to the location identified by the warning; errors 418 and warnings 420 may be distinguished in some situations, e.g., as to relative severity or available responses, but for present purposes that distinction is not important, because each may result in or correspond with a location in an anchor target list 404
422 software development generally
424 software development tool, e.g., compiler, debugger, profiler, or other tool 122 which is utilized to create software, evaluate software, modify software, deploy software, or otherwise facilitate software usage or performance
426 parser, e.g., lexical analysis software, compiler, interpreter, lint tool, machine learning tool, or another tool that performs syntactic analysis or semantic analysis or both
428 parser information, e.g., syntactic or semantic information in an abstract syntax tree or determined by a parser 426, including structural info (e.g., “this text is in the scope of a class declaration”) or warnings or errors (e.g., “this variable has already been declared”), or both
430 refinement constraint
432 semantic word association, e.g., (“positive”, “negative”), (“<”, (“low”, “medium”, “high”)
434 data structure representing word association 432, e.g., as tuple, in list or array, by statistical or other measure of likelihood words are used together; may include for example data structures used for natural language processing
436 copy tracking data structure; represents a location in a document of a copied section; in some implementations also includes a copy of the copied section's content at the time of copying; may be implemented, e.g., using adapted edit history data structures such as undo data structures or version control data structures
438 paste tracking data structure; represents a location in a document of a pasted section; in some implementations also includes a copy of the pasted section's content at the time of pasting; may be implemented, e.g., using adapted edit history data structures such as undo data structures or version control data structures
500 a data structure, transform identifier, or other digital representation of a proposed change 312
502 refactoring; e.g., command to alter a routine's parameter list as to parameter order, number of parameters, or parameter type, or alter a routine's return value presence or type, or change dependency as to APIs, or to perform any of the following TEP items: Extract Constant, Move Static Method, Insert parameter & add args at callsites, Delete parameter & drop args at callsites, Promote local variable to field, Add Property-Parameter-Assignment, Add Property-Constructor1, Introduce Local Variable, Generate a method, Multiple Insert Parameter refactoring, Multiple Delete Parameter refactoring, Apply all use implicit type in a block, Apply all remove ‘this’ qualification, Multiple Add Property-Parameter-Assignment, or Change Type & rename; also refers to a result of such a command, or any code change that maintains program functionality
504 reordering of characters, words, tokens, lines, declarations, paragraphs, or other units of a document
506 format change, e.g., reformatting or format conversion
508 string, e.g., one or more adjacent characters; digital
510 string replacement; performed computationally
512 string insertion; performed computationally
514 string deletion; performed computationally; a string movement may be understood as a string insertion plus a string deletion (in either order)
516 regular expression, also referred to as “regex”; an example of a transform 218
602 user interface (UI) mechanism, e.g., diff view, window, menu, and so on
604 user commands; actuating a transform is one kind of command
606 editing workflow, e.g., a sequence of interactions between a user and a system, with attendant metadata as to the current goal of the interaction and how that goal relates (or fails to relate) to other goals of an edit session
608 command to accept a suggestion 214; acceptance by user of a suggestion 214; performed computationally
610 command to reject a suggestion 214; rejection by user of a suggestion 214; performed computationally
612 command to modify a suggestion 214; modification by user of a suggestion 214; performed computationally
614 diff view in a user interface, e.g., a before-and-after display of source code illustrating the effect of performing a recommended transform, which shows the “before” version of the source in the same location it was in before the transform was recommended, and shows the “after” version next to the “before” version
616 clickable or pressable or otherwise selectable button in a UI, may include a hyperlink
618 computational action performed in response to user selection
620 input device, e.g., keyboard, mouse, touch screen, microphone, etc.
622 ambient visualization screen region (AVSR); also known as ambient visualization area or ambient display area; for a given time period, a screen area of height ten lines or less within which a user focused for more than half the time period (verifiable by eye tracking or user survey, for example) or in which an edit caret remained, or a mouse hover location remained
624 request or command to undo a prior computational action
702 source code (in digital form); an example of text 320
704 prose (in digital form), e.g., natural language or other text which is not fully parseable by a compiler except as a block of comment content; an example of text 320
706 token produced by parser, e.g., node in an abstract syntax tree
708 variable, e.g., a data storage location that is named or that takes on multiple values during execution of a program, or both
710 string or other identifier of a variable, constant, class, module, file, port, library, or other item or software development artifact or construct in a source code document; digital
712 declaration of a variable, class, routine, or other item in a source code document; digital
714 function or method (in the computing sense) or other routine in a source code document; digital
716 parameter or argument of a routine in a source code document; may include, e.g., an identifier and a data type; digital
718 comment portion of a source code text; text within a comment or a remark, from the perspective of a parser; digital
720 non-comment portion of a source code text; text not within a comment or a remark, from the perspective of a parser; digital
722 location or range of contiguous locations within a document 132 designated manually or automatically for potential change
724 text insertion point of a document in an editor; the location where typed or pasted text would be inserted; may be indicated by a vertical bar |, or by some other visual indicator, or may be present without a visual indicator; in editors that recognize multiple input devices, such as a keyboard and a mouse, a distinction may be made between a text insertion point and a cursor location in that a cursor may be positioned by mouse movements without changing the text insertion point, and the text insertion point may change without moving the mouse cursor; sometimes a mouse operation, e.g., a double-click, may be used to change the text insertion point to match the mouse cursor location
726 document metadata, e.g., owner identification, timestamp, access settings or permissions, version control information
800 flowchart; 800 also refers to edit automation methods illustrated by or consistent with the FIG. 8 flowchart
802 computational copy-paste-update operations generally
804, 806 computationally copy a section of a document from a working copy of the document residing in the editor tool (e.g., as a result of an “open” file command) into a buffer such as a cut-and-paste buffer, thereby making a copy of that section of the document, which is referred to herein as the “copied section”; two reference numerals (804 and 806) are used here in order to give each verb a respective reference numeral in conformance with patent practices, but the operations are unitary in the sense that copying 804 the copied section makes 806 a copy of the copied section
808, 810 computationally paste a copied section of a document from a buffer such as a cut-and-paste buffer into a working copy of the document residing in the editor tool, thereby creating a pasted section of the document; two reference numerals (808 and 810) are used here in order to give each verb a respective reference numeral in conformance with patent practices, but the operations are unitary in the sense that pasting 810 into the document creates 808 a pasted section
812 computationally gather copy-paste context 302, e.g., additional document text adjacent to a pasted section or a copied section or both, parser information about the pasted section or a copied section or both, edit history such as whether multiple pasted sections were created from the same copied section or what edits (if any) a user has done within a pasted section, and other information usable by an automatic suggestion generator as a basis for generating a suggestion; may be accomplished, e.g., by populating a context 302 data structure; gathering 812 is presumed by submitting 814 since otherwise there is no data to submit 814
814 computationally submit data to an automatic suggestion generator, e.g., via one or more of shared memory, procedure call, or network transmission
816 computationally get data from an automatic suggestion generator, e.g., via one or more of shared memory, procedure call, or network transmission
818 computationally leverage a transform
820 computationally apply, e.g., execute, a transform or other suggestion
822 computationally recommend, e.g., via a UI, a transform or other suggestion
900 flowchart; 900 also refers to edit automation methods illustrated by or consistent with the FIG. 9 flowchart (which incorporates the steps of FIG. 8)
902 computationally show on a display one or more copied section locations, one or more pasted section locations, or both, for part or all of a document
904 computationally actuate (e.g., call, invoke, initiate execution) a subtool 326
906 computationally avoid switching between input devices as user input sources, e.g., avoid allowing use only of a keyboard for a first operation in an edit sequence followed by allowing use only of a mouse for the next operation
908 computationally avoid requesting a set of selections from a user when that request requires the user to choose from a set of three or more displayed constraints; in particular, avoid asking users to check boxes on a list of a dozen or more constraints
910 computationally submit a refinement constraint; may follow the same data format as a context 302 submission 814 generally or use a different format
912 computationally display a missed edit warning 414; note that a warning 414 may be merely presumptive in that the user may have intentionally not edited a particular pasted section
914 computationally display a recommendation, e.g., by configuring a display 126
918 computationally position a text insertion point in a document that is open for editing
920 computationally acquire user feedback 412
922 computationally perform an edit of a pasted section under manual control of a user as opposed to an edit which applies 820 a suggestion
924 computationally avoid displaying a recommendation outside AVSR
926 computationally save a transform definition or other suggestion to memory in a retrievable digital format; this allows a user to avoid repeating edits to re-teach the transform provider to provide the transform in a different file
928 computationally obtain a user command, e.g., via a user interface
930 computationally modify a suggestion
932 computationally note an unedited pasted section among a set of pasted sections, particularly pasted sections that share copied text
934 computationally note a compiler warning or error in a pasted section
936 computationally stay within a workflow while editing a pasted section
938 any step discussed in the present disclosure that has not been assigned some other reference numeral

### CONCLUSION

In short, the teachings herein provide a variety of edit automation functionalities 210 which operate in enhanced systems 202. Edit automation functionality 210 generalizes edits 310 performed by a user in a document 132. Embodiments automate several aspects of document 132 copy-paste updates 802. An enhanced editor 204 or other enhanced tool 204 submits 814 copy-paste context 302, such as a copied section 316, a pasted section 318, nearby text 320, or parser information 428, to an automatic suggestion generator 206. The tool 204 gets 816 back a suggestion 214 for automatically changing 312 the pasted section 318, thus helping users 104 avoid tedium and errors. For instance, string 508 substitutions 510 begun by the user 104 can be automatically and easily completed 820 within the pasted section 318. Refactoring 502 between variable 708 declarations 712 and parameter 716 lists in a function 714 is detected by the automatic suggestion generator 206 and completed 820 by the tool 204 on request 608. Situation-specific transforms 218 based on code synthesis 216, word associations 432, temporal edit patterns 402, anchor target lists 404, regular expressions 516, or autocompletion 224 are offered 822. Suggestions 214 are given 822 inside 936 the user's current workflow 606 to avoid breaks in user focus. Suggestions 214 can be refined 910 automatically in response to implicit or explicit user feedback 412. Users 104 are warned 912 of unedited pasted sections 318, to help avoid accidental omissions. Source code 702 review is aided by highlighting 902 pasted section 318 locations 722, copied section 316 locations 722, or both. Other capabilities and advantages are also described herein.

Embodiments are understood to also themselves include or benefit from tested and appropriate security controls and privacy controls such as the General Data Protection Regulation (GDPR), e.g., it is understood that appropriate measures should be taken to help prevent misuse of computing systems through the injection or activation of malware in documents. Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 8, 9, 10, and 13 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of runtimes or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system configured to receive a copy-paste editing operation sequence and then automatically recommend or apply an additional editing operation, the system comprising:
a digital memory;
a processor in operable communication with the digital memory, the processor configured to perform editing automation steps including (a) making a copy at least in part by copying a copied section of a first document, (b) creating a pasted section at least in part by pasting the copy into the first document or into a second document, (c) automatically and proactively submitting a copy-paste context to an automatic suggestion generator, (d) getting a suggestion from the automatic suggestion generator in response to the submitting, the suggestion including a proposed change to the pasted section, and (e) leveraging the suggestion by applying the proposed change to the pasted section or by recommending application of the proposed change to the pasted section, or both;
wherein the submitting submits the copy-paste context to at least one of the following automatic suggestion generators: a transform synthesizer, or an automatable edit sequences library containing temporal edit patterns; and
wherein the copy-paste context includes at least one of the following: at least a portion of the copied section, at least one word of text adjacent to the copied section, or at least one word of text adjacent to the pasted section.

2. The computing system of claim 1, further comprising at least one of the first or second documents, wherein the at least one of the first or second documents resides in the digital memory and includes at least one of the following:
a paste tracking data structure which identifies at least a location of the pasted section and indicates that the pasted section was pasted into the at least one of the first or second documents; or
a copy tracking data structure which identifies at least a location of the copied section and indicates that the copied section was copied into a memory buffer from which content can be pasted into the at least one of the first or second documents.

3. The computing system of claim 1, further comprising the first document, wherein the first document resides in the digital memory, and wherein the first document includes at least one of the following:
text which includes computer program source code;
text which adheres to a syntax that is automatically parseable into tokens; or
text which includes natural language prose.

4. The computing system of claim 1, further comprising a proposed change data structure in the digital memory, the proposed change data structure representing the proposed change, and wherein the proposed change includes at least one of the following:
a string replacement;
a string insertion;
a string deletion;
a string movement;
a source code refactoring;
a reordering of source code tokens;
a reordering of characters;
a reordering of words;
a reordering of lines of text;
a format change; or
an autocompletion.

5. The computing system of claim 1, further comprising a word associations data structure in the digital memory, the word associations data structure representing word associations, wherein the proposed change includes a change from a first word to a second word, and the word associations data structure represents an association between the first word and the second word.

6. A method for edit automation, the method performed by an editor program, the method comprising:
making a copy at least in part by copying a copied section of a first document;
creating a pasted section at least in part by pasting the copy into the first document or into a second document;
automatically and proactively submitting a copy-paste context to an automatic suggestion generator;
getting a suggestion from the automatic suggestion generator in response to the submitting, the suggestion including a proposed change to be made only in the pasted section in the absence of user instructions that the proposed change also be made outside the pasted section, the proposed change including at least one of: a source code refactoring, a reordering of source code tokens, a reordering of lines of text, or a format change; and
leveraging the suggestion, by applying the proposed change to the pasted section only, or by recommending application of the proposed change to the pasted section only, or both;
wherein the copy-paste context includes at least the copied section or the pasted section.

7. The method of claim 6, wherein the method further comprises performing an edit of the pasted section before submitting the copy-paste context, and wherein the copy-paste context includes a digital representation of the edit.

8. The method of claim 6, wherein the copy-paste context further includes at least one of the following:
source code which is outside the copied section and which is separated from the copied section by at most one hundred lines;
parser information which represents the copied section;
source code which is outside the pasted section and which is separated from the pasted section by at most one hundred lines; or
parser information which represents the pasted section.

9. The method of claim 6, wherein:
the method creates multiple pasted sections by pasting the copy multiple times;
at least one of the multiple pasted sections is edited in response to one or more commands from a user; and then
the method further comprises automatically and proactively displaying a warning to the user that at least another of the multiple pasted sections has not been edited.

10. The method of claim 6, wherein:
the pasted section includes multiple variable identifiers; and
the proposed change includes a refactoring of a source code which recites at least two of the variable identifiers.

11. The method of claim 6, wherein at least one of the following conditions is satisfied:
the proposed change includes a first proposed change to a first identifier in a source code non-comment portion of the pasted section and also includes a second proposed change to a second identifier in the source code non-comment portion; or
the proposed change includes a first proposed change to an identifier in a source code non-comment portion of the pasted section and also includes a second proposed change to a string in a source code comment portion of the pasted section.

12. The method of claim 6, wherein the method further comprises automatically and proactively repositioning a text insertion point within the pasted section to match a location of the proposed change.

13. The method of claim 6, wherein:
the pasted section includes a variable; and
the proposed change includes a function which can receive the variable as a parameter.

14. The method of claim 6, wherein the copy-paste context further includes parser information.

15. The method of claim 6, wherein the submitting submits the copy-paste context to at least one of the following automatic suggestion generators:
a transform synthesizer;
an automatable edit sequences library containing temporal edit patterns; or
an autocompletion code generator.

16. A computer-readable storage device configured with data and instructions which upon execution by a processor cause a computing system to perform a method for edit automation, the method comprising:
making a copy at least in part by copying a copied section of a first document;
creating a pasted section at least in part by pasting the copy into the first document or into a second document;
automatically and proactively submitting a copy-paste context to an automatic suggestion generator;
getting a suggestion from the automatic suggestion generator in response to the submitting, the suggestion including a proposed change, the proposed change including at least one of: a source code refactoring, or a reordering of source code tokens; and
recommending application of the proposed change to the pasted section only;
wherein the copy-paste context includes at least the copied section or the pasted section.

17. The configured storage device of claim 16, wherein the method further comprises at least one of the following:
obtaining via a user interface an accept command, and in response applying the proposed change to the pasted section;
obtaining via the user interface a reject command, and in response avoiding applying the proposed change to the pasted section; or
obtaining via the user interface a modify command, modifying the proposed change into a modified proposed change, and applying the modified proposed change to the pasted section.

18. The configured storage device of claim 16, wherein the method further comprises:
acquiring a user feedback about the proposed change;
submitting a refinement constraint to the automatic suggestion generator, the refinement constraint being based on the user feedback;
getting a refined proposed change from the automatic suggestion generator; and
leveraging the refined proposed change by applying the refined proposed change or by recommending application of the refined proposed change, or both.

19. The configured storage device of claim 16, wherein recommending application of the proposed change stays within a current editing workflow.

20. The configured storage device of claim 16, the method further comprising:
creating a second pasted section; and
recommending application of the proposed change to the second pasted section only.
